(19) United States
(12) Patent Application Publication
(10) Pub. No.: US 2026/0250991 A1
(43) Pub. Date: Aug. 27, 2026

(54) DOOR LOCK SYSTEM

(71) Applicant: AISIN CORPORATION, Kariya (JP)

(72) Inventors: Ryu GOTO, Kariya-shi (JP); Ryo ASANO, Kariya-shi (JP)

(73) Assignee: AISIN CORPORATION, Kariya (JP)

(21) Appl. No.: 19/545,687

(22) Filed: Feb. 20, 2026

(30) Foreign Application Priority Data
Feb. 26, 2025 (JP) 2025-028809

(51) Int. Cl. E05B 81/56; E05B 81/06; E05B 81/16; E05B 81/18; E05B 81/30; E05B 81/72

(52) U.S. Cl. CPC E05B 81/56; E05B 81/06; E05B 81/16; E05B 81/18; E05B 81/30; E05B 81/72

(57) ABSTRACT

A door lock system includes: a plurality of door lock devices each including a latch mechanism, a lock mechanism, a double lock mechanism, a motor, and a detector, the double lock mechanism alternately switching between a double lock set state and a double lock unset state by driving the motor in one direction; and a control device configured to, when switching of the state of the double lock mechanism is requested, perform drive control in the one direction of the motor of the door lock device where the double lock mechanism state does not match a requested switch destination state, and not perform drive control in the one direction of the motor of the door lock device where the double lock mechanism state matches the requested switch destination state.

### CROSS REFERENCE TO RELATED APPLICATIONS

This application is based on and claims priority under 35 U.S.C. § 119 to Japanese Patent Application No. 2025-028809, filed on February 26, 2025, the entire content of which is incorporated herein by reference.

### TECHNICAL FIELD

The present specification discloses a door lock system.

### BACKGROUND DISCUSSION

As this type of conventional door lock system, a door lock system has been proposed that includes a double lock mechanism driven by a motor (see, for example, JP 2000-45592 A).

A door lock system is considered in which a door lock device including a double lock mechanism is mounted in each of a plurality of doors of a vehicle, and the double lock mechanism is configured to alternately set and release double lock every time a motor is driven in one direction. In such a system, usually, when a double lock setting request is made, the double lock is set for the door lock devices of all the doors, and when a double lock unsetting request is made, the double lock is released for the door lock devices of all the doors. However, in this system, there may be a case where double lock states do not match between the doors. Such a case may occur, for example, when an operator urgently releases the double lock of one door (a door on a driver's seat side) of a vehicle in a door lock system where a door lock device mounted in the one door has a function of urgently releasing the double lock by operating a key cylinder. In this case, when the motors of the door lock devices of all the doors are simultaneously driven in one direction in response to a normal double lock setting or unsetting request, the double lock states cannot be matched between the one door that has been urgently released and the other doors.

A need thus exists for a door lock system which is not susceptible to the drawback mentioned above.

### SUMMARY

A door lock system includes: a plurality of door lock devices respectively provided in a plurality of doors of a vehicle; and a control device configured to control the plurality of door lock devices, in which each of the plurality of door lock devices includes: a latch mechanism configured to selectively form a latched state in which a corresponding door is held in a closed state, and an unlatched state in which opening of the corresponding door is allowed; a lock mechanism configured to selectively form a locked state in which switching of the latch mechanism to the unlatched state is prohibited, and an unlocked state in which the switching of the latch mechanism to the unlatched state is allowed; a double lock mechanism configured to selectively form a double lock set state in which switching of the lock mechanism to the unlocked state is prohibited, and a double lock unset state in which the switching of the lock mechanism to the unlocked state is allowed; a motor configured to drive the double lock mechanism; and a detector configured to detect a state of the double lock mechanism, the double lock mechanism alternately switches between the double lock set state and the double lock unset state by driving the motor in one direction, and when switching of the state of the double lock mechanism is requested, the control device performs drive control in the one direction of the motor of, among the plurality of door lock devices, the door lock device where the state of the double lock mechanism detected by the detector does not match a state of a requested switch destination, and does not perform drive control in the one direction of the motor of the door lock device where the state of the double lock mechanism detected by the detector matches the state of the requested switch destination.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration view illustrating a vehicle where a door lock system of the present disclosure is mounted;

FIG. 2 is a schematic configuration view of a door lock device in an unlocked state;

FIG. 3 is a schematic configuration view of the door lock device in the unlocked state;

FIG. 4 is a schematic configuration view of the door lock device in a locked state and a double lock unset state;

FIG. 5 is a schematic configuration view of the door lock device in the locked state and the double lock unset state;

FIG. 6 is a schematic configuration view of the door lock device in a double lock set state;

FIG. 7 is a schematic configuration view of the door lock device in the double lock set state;

FIG. 8 is a schematic configuration view of the door lock device when an inside door handle is operated from the unlocked state;

FIG. 9 is a schematic configuration view of the door lock device when the inside door handle is operated from the unlocked state;

FIG. 10 is a schematic configuration view of the door lock device when a push-type cam mechanism is in an operating state;

FIG. 11 is a schematic configuration view of the door lock device when the push-type cam mechanism is in the operating state;

FIG. 12 is a schematic configuration view of the door lock device when the door lock device is switched from the double lock set state to an unlatched state by driving of a motor;

FIG. 13 is a schematic configuration view of the door lock device when the door lock device is switched from the double lock set state to the unlatched state by driving of the motor;

FIG. 14 is a control block diagram of the door lock device;

FIG. 15 is a flowchart illustrating an example of a double lock setting control routine;

FIG. 16 is a flowchart illustrating an example of a double lock unsetting control routine;

FIG. 17 is a flowchart illustrating an example of the double lock unsetting control routine;

FIG. 18 is a control block diagram of a door lock device according to another embodiment;

FIG. 19 is a control block diagram of a door lock device according to another embodiment; and

FIG. 20 is a control block diagram of a door lock device according to another embodiment.

### DETAILED DESCRIPTION

Next, embodiments for carrying out the present disclosure will be described with reference to the drawings.

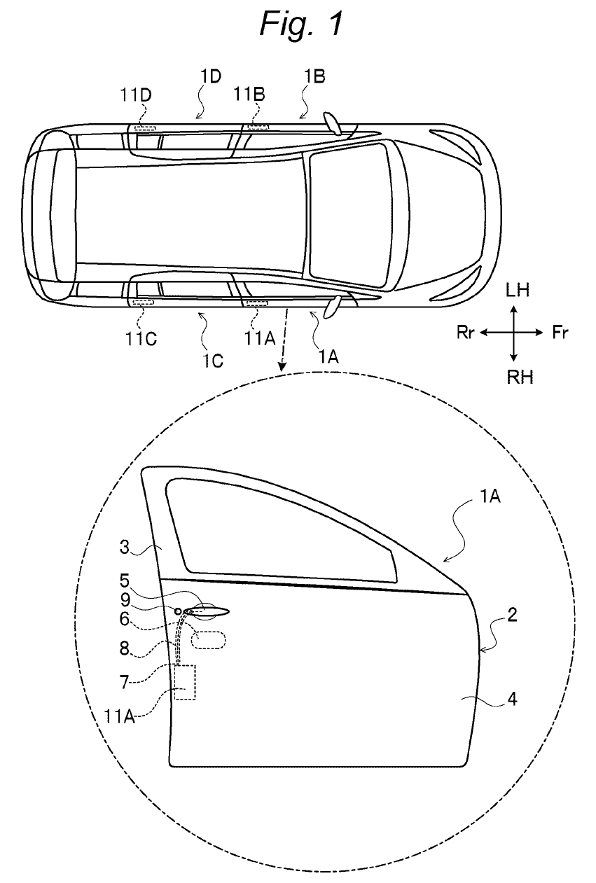

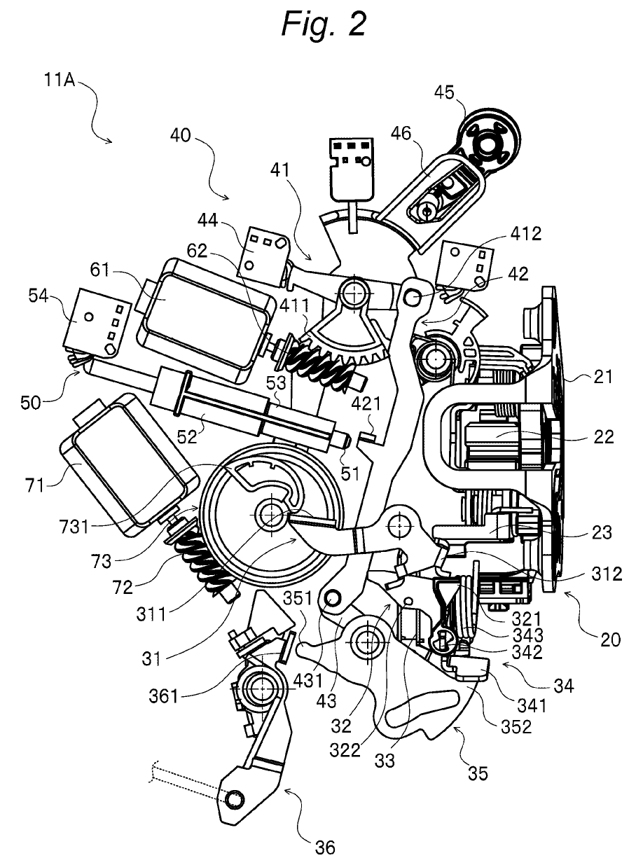

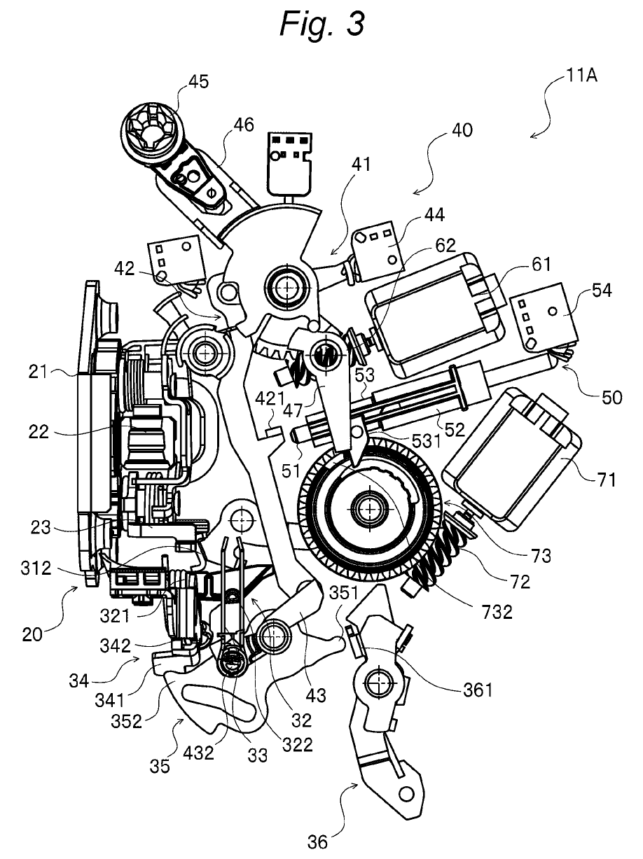

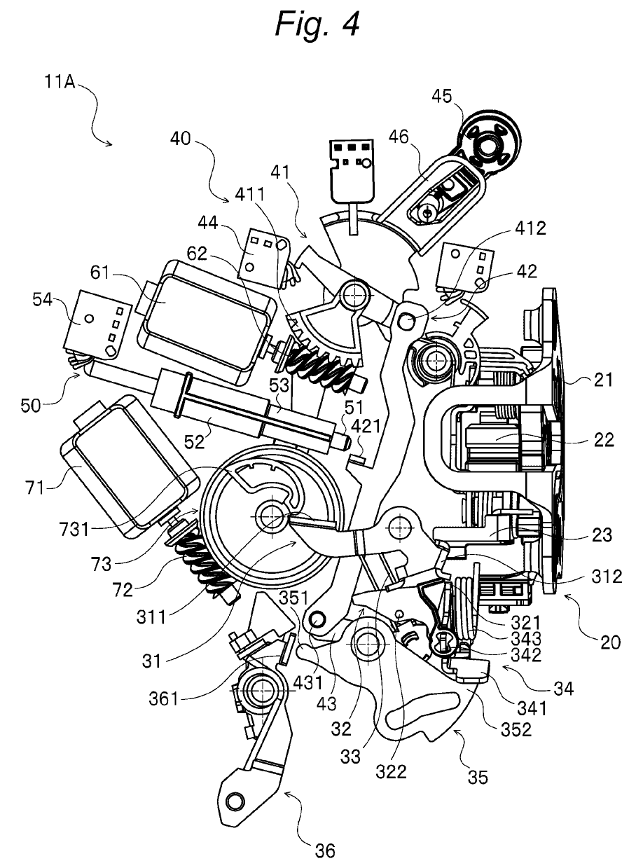

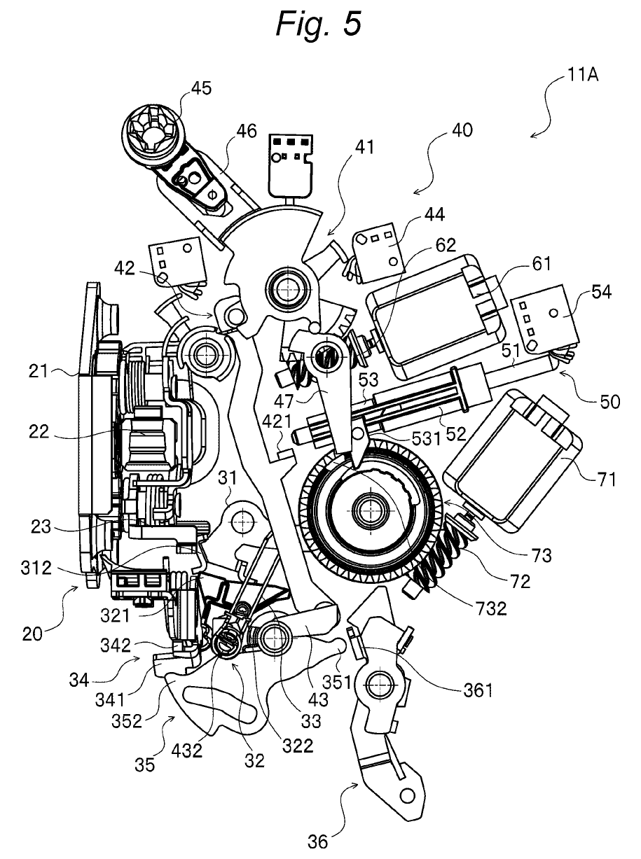

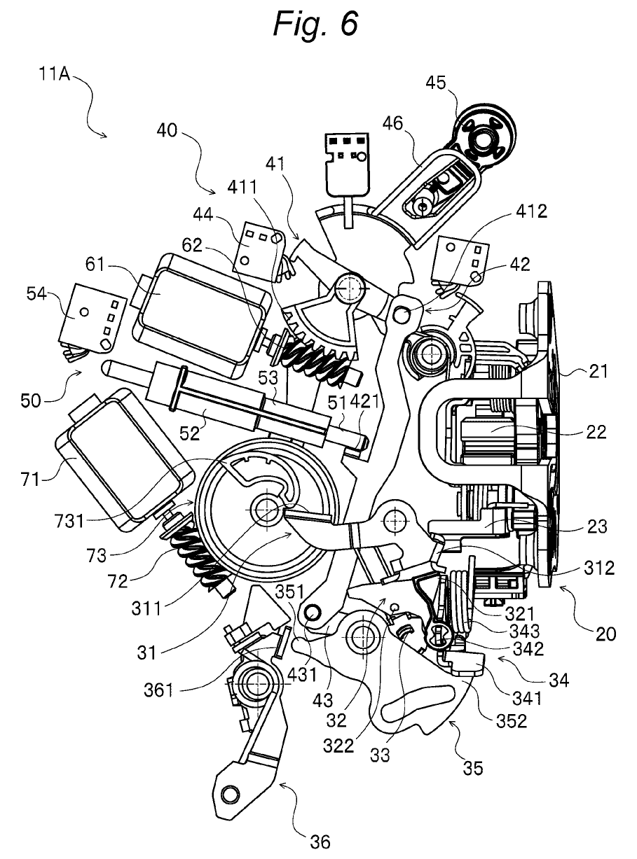

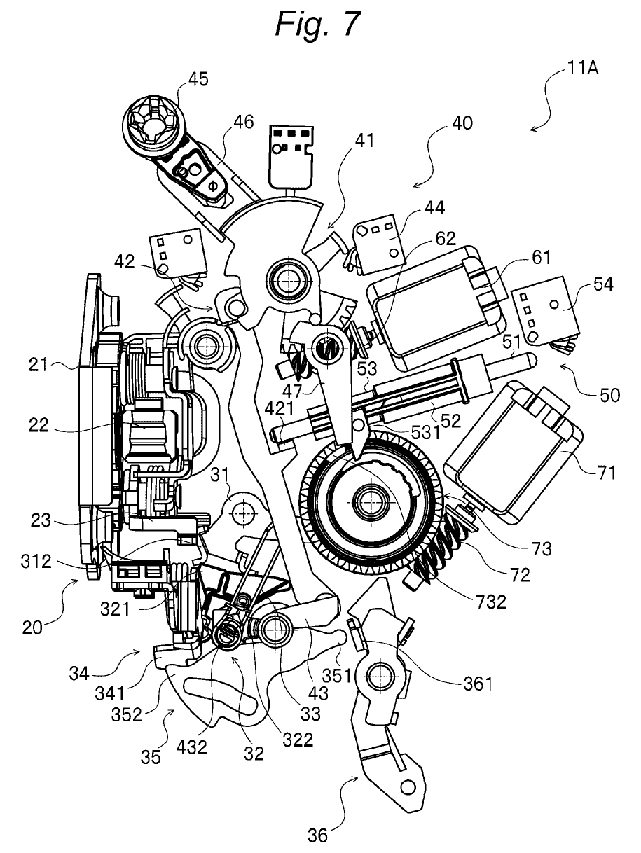

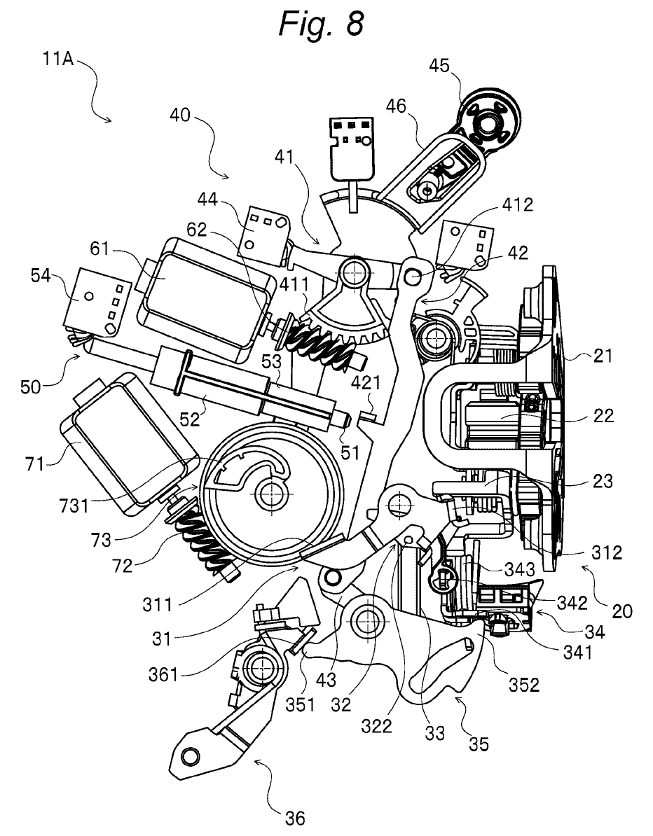

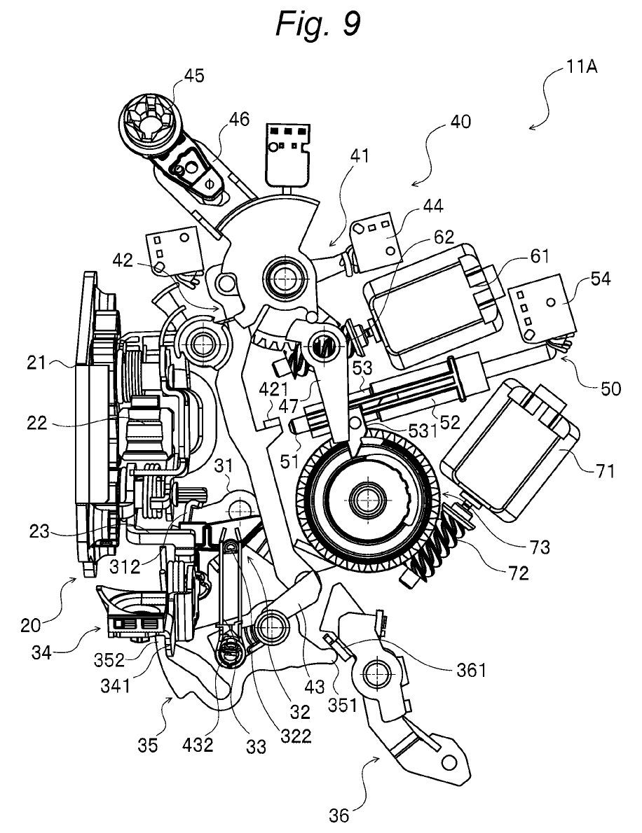

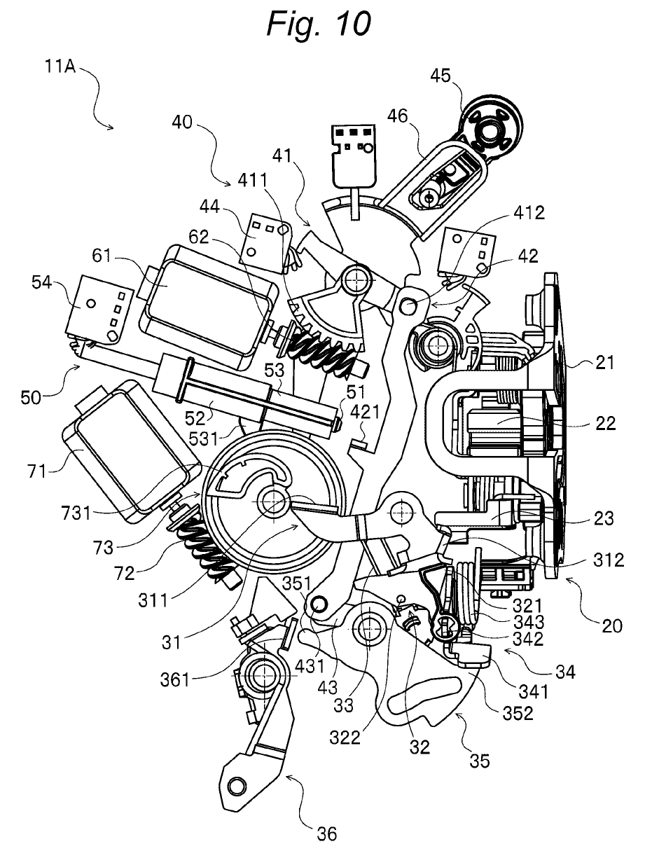

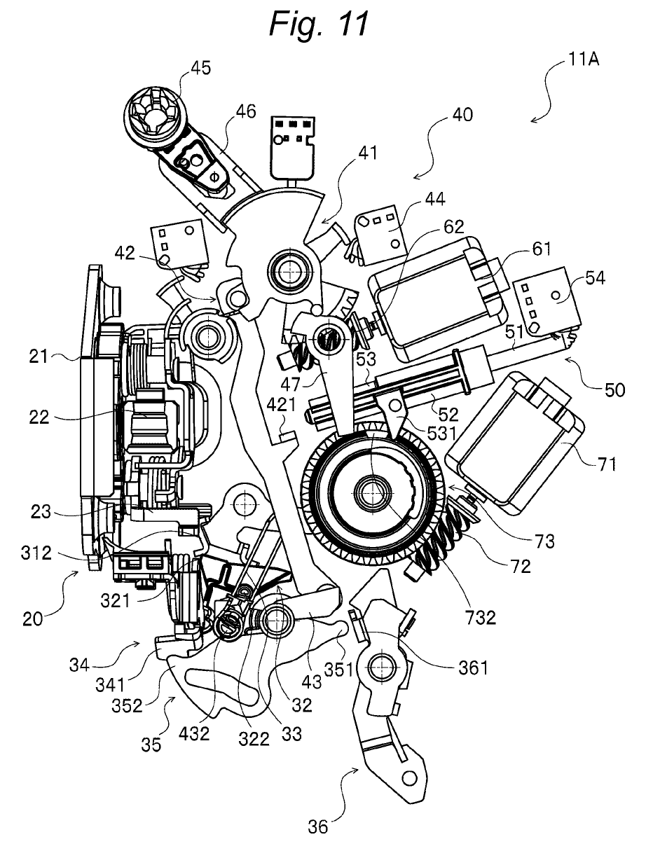

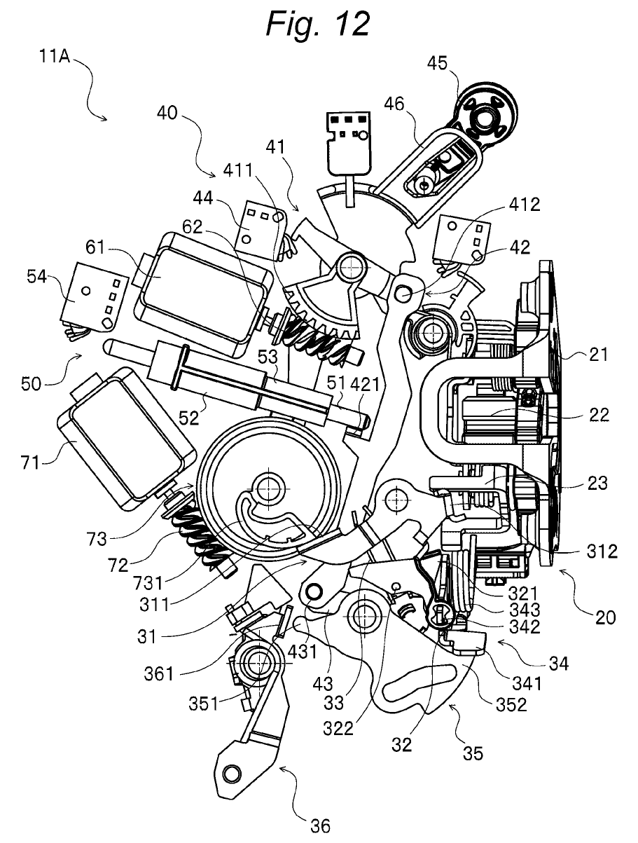

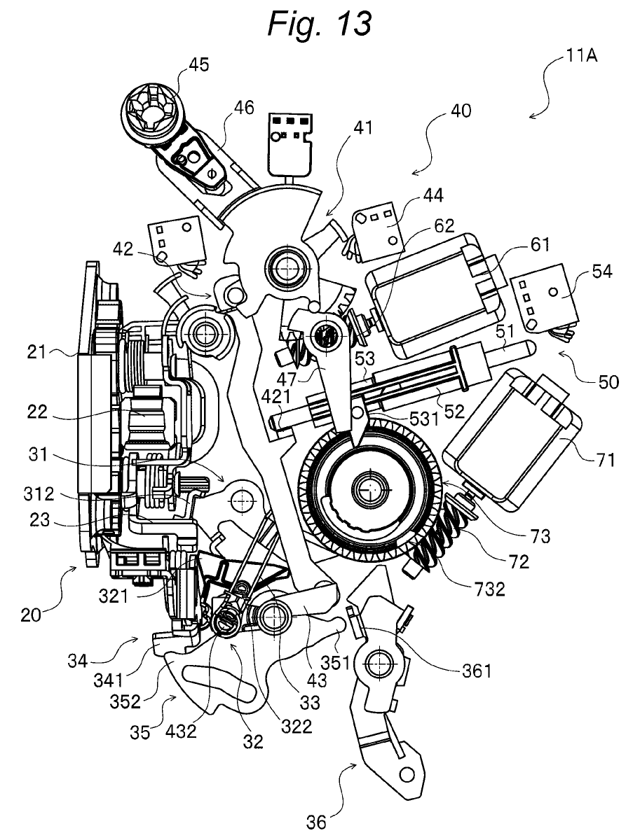

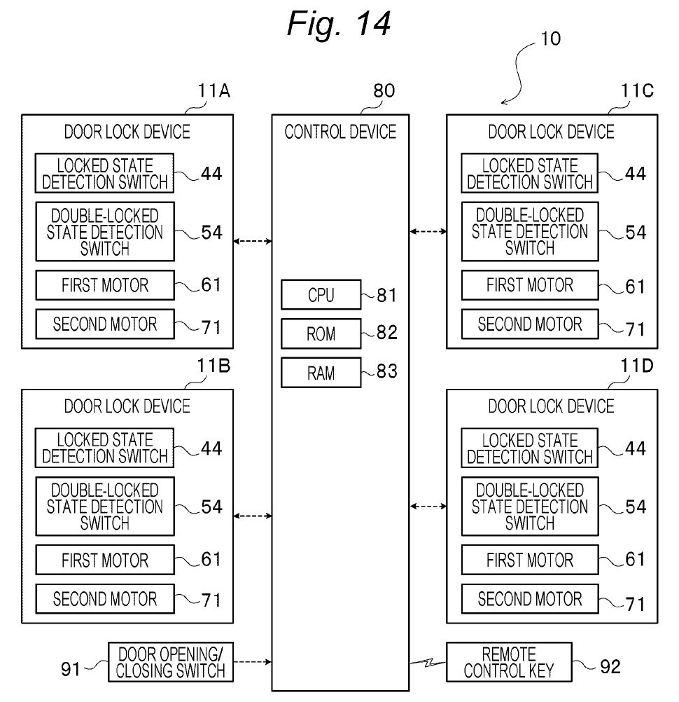

FIG. 1 is a schematic configuration view illustrating a vehicle where a door lock system 10 of the present disclosure is mounted. FIGS. 2 and 3 are schematic configuration views of a door lock device 11A in an unlocked state. FIGS. 4 and 5 are schematic configuration views of the door lock device 11A in a locked state and a double lock unset state. FIGS. 6 and 7 are schematic configuration views of the door lock device 11A in a double lock set state. FIGS. 8 and 9 are schematic configuration views of the door lock device 11A when an inside door handle 6 is operated from the unlocked state. FIGS. 10 and 11 are schematic configuration views of the door lock device 11A when a push-type cam mechanism is in an operating state. FIGS. 12 and 13 are schematic configuration views of the door lock device 11A when the door lock device 11A is switched from the double lock set state to an unlatched state by driving of a second motor 71. FIG. 14 is a control block diagram of the door lock device 11A.

As illustrated in FIG. 1, in the present embodiment, the vehicle includes doors 1A, 1B, 1C, and 1D of a driver’s seat, a passenger seat, and on the left and right of a rear seat. The door 1A is a door on the driver’s seat side (FrRH), the door 1B is a door on the passenger seat side (FrLH), the door 1C is a door on the right side of the rear seat (RrRH), and the door 1D is a door on the left side of the rear seat (RrLH). The vehicle may not include the doors of the rear seat or may include a back door.

Each of the doors 1A, 1B, 1C, and 1D includes a door body 2 forming a lower half portion of the door and a door sash 3 forming an upper half portion of the door and guiding a window glass as illustrated in FIG. 1. The door body 2 includes an outer panel 4, an inner panel (not illustrated) fixed to an inner side (vehicle interior side) of the outer panel 4, and a trim (not illustrated) made of resin fixed to a surface on the vehicle interior side of the inner panel. Each of the doors 1A, 1B, 1C, and 1D is pivotable from a fully-closed position to a fully-open position through a half-open position (half-closed position), with its front end rotatably supported by a vehicle body (not illustrated) of the vehicle as a fulcrum. The half-open position is a position moved slightly toward the open position from the fully-closed position.

Each of the doors 1A, 1B, 1C, and 1D also includes an outside door handle 5 attached to the outer panel 4 in a pullable or pivotable manner, and the inside door handle 6 attached to the trim in a pullable or pivotable manner. The outside door handle 5 and the inside door handle 6 are biased to initial positions by springs (not illustrated) or the like. A user of the vehicle can open each of the doors 1A, 1B, 1C, and 1D by manually operating the outside door handle 5 or the inside door handle 6 to move the outside door handle 5 or the inside door handle 6 from the initial position to a door open position. A key cylinder 9 that can be manually operated by the user is disposed on the outer panel 4 of the door 1A of the driver's seat.

As illustrated in FIG. 1, the door lock system 10 includes door lock devices 11A, 11B, 11C, and 11D installed in the doors 1A, 1B, 1C, and 1D, respectively, and a control device 80 (see FIG. 14) that controls the entire system.

As illustrated in FIG. 1, each of the door lock devices 11A, 11B, 11C, and 11D is disposed in an internal space defined by the outer panel 4 and the inner panel (not illustrated) of the corresponding door 1A, 1B, 1C, or 1D. More specifically, each of the door lock devices 11A, 11B, 11C, and 11D is fixed to, for example, the inner panel so as to be located below the outside door handle 5 in the internal space. Each of the door lock devices 11A, 11B, 11C, and 11D is connected to the outside door handle 5 through a cable (inner cable) 7 and an outer cylindrical member (outer casing) 8 each having flexibility. The cable 7 is inserted into the outer cylindrical member 8, and the cable 7 and the outer cylindrical member 8 transmit the movement of the outside door handle 5 from the initial position to the door open position to each of the door lock devices 11A, 11B, 11C, and 11D.

As illustrated in FIGS. 2 to 13, the door lock device 11A disposed in the door 1A on the driver’s seat side includes a latch mechanism 20, a lock mechanism 40, a double lock mechanism 50, a first motor 61, the second motor 71, and a rotating member 73. The door lock device 11B disposed in the door 1B on the passenger seat side and the door lock devices 11C and 11D disposed in the doors 1C and 1D of the rear seat are similar to the door lock device 11A except that double lock cannot be urgently released by operating the key cylinder 9, which will be described later, and thus, the description thereof is omitted.

The latch mechanism 20 is configured to be able to selectively form a fully-latched state in which the door 1A is held at the fully-closed position, a half-latched state in which the door 1A is held at the half-open position located slightly closer to the open side with respect to the fully-closed position, and an unlatched state in which opening of the door 1A is allowed. The fully-latched state and the half-latched state may be referred to as a latched state. The latch mechanism 20 includes a base plate 21, a latch 22, a lift lever 23, a release lever 31, an open link 32, an outside open lever 34, an inside lever 35, and an inside open lever 36.

The latch 22 includes a cutout portion (not illustrated) engageable with a striker (not illustrated) fixed to the vehicle body. The latch 22 is supported rotatably with respect to the base plate 21, and is movable to a fully-latched position, a half-latched position, and an unlatched position by rotation. In the fully-latched position, the striker of the vehicle body is held in the cutout portion of the latch 22, whereby the door 1A is held at the fully-closed position. In the half-latched position, the door 1A is held at the half-open position while the striker of the vehicle body is being held in the cutout portion of the latch 22. In the unlatched position, the striker is released from the cutout portion of the latch 22, and the opening of the door 1A is allowed.

The latch 22 is biased in a direction of releasing the striker by a latch spring (not illustrated). The latch 22 is held at the fully-latched position or the half-latched position by the lift lever 23 restricting rotation in the direction of releasing the striker at the fully-latched position or the half-latched position.

The lift lever 23 is supported rotatably with respect to the base plate 21, and is selectively movable to an initial position and an operating position by rotation. When located at the initial position, the lift lever 23 restricts the rotation of the latch 22 in the direction of releasing the striker. On the other hand, when moving to the operating position, the lift lever 23 releases the restriction on the rotation of the latch 22 in the direction of releasing the striker. As a result, the latch 22 is moved to the unlatched position by the latch spring to release the striker, so that the door 1A can be opened.

The release lever 31 is supported rotatably with respect to a housing (not illustrated) of the door lock device 11A, and is selectively movable to an initial position and an operating position by rotation. When located at the initial position, the release lever 31 locates the lift lever 23 at the initial position. When moving to the operating position, the release lever 31 presses the lift lever 23 to move the lift lever 23 to the operating position. The release lever 31 includes a rotating member engagement portion 311 and a lift lever engagement portion 312.

The open link 32 is supported rotatably with respect to the outside open lever 34. Therefore, the open link 32 is relatively rotatable with respect to the outside open lever 34 and is movable integrally with the outside open lever 34. The open link 32 is movable to an unlocked position (see FIGS. 2 and 3) and a locked position (see FIGS. 4 and 5) by relatively rotating with respect to the outside open lever 34. Furthermore, the open link 32 is movable to an initial position and an operating position by moving together with the outside open lever 34 at each of the unlocked position and the locked position.

The open link 32 includes a release lever engagement portion 321 and a spring engagement portion 322. When the open link 32 is moved from the initial position to the operating position by the outside open lever 34 while being located at the unlocked position, the release lever engagement portion 321 engages with the release lever 31 to press the release lever 31 and move the release lever 31 from the initial position to the operating position. As a result, the lift lever engagement portion 312 of the release lever 31 engages with the lift lever 23 to press the lift lever 23 and move the lift lever 23 from the initial position to the operating position, whereby the latch mechanism 20 is switched to the unlatched state. The open link 32 is configured such that the release lever engagement portion 321 does not engage with (come into contact with) the release lever 31 when the open link 32 moves from the initial position to the operating position while being located at the locked position. Therefore, in a state where the open link 32 is located at the locked position, the latch mechanism 20 cannot be switched to the unlatched state. The spring engagement portion 322 is a protrusion that protrudes in a direction parallel to an axial direction of a rotation axis of the open link 32 with respect to the outside open lever 34. An open link biasing spring 33 is engaged with the spring engagement portion 322.

The outside open lever 34 is supported rotatably with respect to the housing, and is selectively movable to an initial position and an operating position by rotation. The outside open lever 34 is biased to the initial position by an outside open lever biasing spring 343. The outside open lever 34 is linked with the outside door handle 5 of the door 1A. When the outside door handle 5 is manually operated, the outside open lever 34 moves from the initial position to the operating position in conjunction with the outside door handle 5. The outside open lever 34 includes an inside lever engagement portion 341 and an open link support portion 342. The open link support portion 342 is a portion that rotatably supports the open link 32.

The inside lever 35 is supported rotatably with respect to the housing, and is selectively movable to an initial position and an operating position by rotation. The inside lever 35 includes an inside open lever engagement portion 351 and an outside open lever engagement portion 352. The outside open lever engagement portion 352 is a portion configured to be engageable with and disengageable from the inside lever engagement portion 341 of the outside open lever 34. When the inside lever 35 moves from the initial position to the operating position, the outside open lever engagement portion 352 engages with the inside lever engagement portion 341 of the outside open lever 34 to press the outside open lever 34 and move the outside open lever 34 from the initial position to the operating position.

The inside open lever 36 is supported rotatably with respect to the housing, and is selectively movable to an initial position and an operating position by rotation. The inside open lever 36 is biased to the initial position by an inside open lever biasing spring. The inside open lever 36 is linked with the inside door handle 6 of the door 1A. When the inside door handle 6 is manually operated, the inside open lever 36 moves from the initial position to the operating position in conjunction with the inside door handle 6. The inside open lever 36 includes an inside lever engagement portion 361. The inside lever engagement portion 361 is a portion configured to be engageable with and disengageable from the inside open lever engagement portion 351 of the inside lever 35. When the inside open lever 36 moves from the initial position to the operating position, the inside lever engagement portion 361 engages with the inside open lever engagement portion 351 of the inside lever 35 to press the inside lever 35 and move the inside lever 35 from the initial position to the operating position.

As described above, the outside open lever 34 moves from the initial position to the operating position by the manual operation of the outside door handle 5, and the inside open lever 36 and the inside lever 35 move from the initial positions to the operating positions by sequentially moving from the initial positions to the operating positions by the manual operation of the inside door handle 6. When the outside open lever 34 moves from the initial position to the operating position in a state where the open link 32 is located at the unlocked position, the open link 32, the release lever 31, and the lift lever 23 sequentially move from the initial positions to the operating positions (see FIGS. 8 and 9), whereby the latch mechanism 20 is switched to the unlatched state. As a result, the user can open the door 1A by manually operating the outside door handle 5 or the inside door handle 6 to switch the latch mechanism 20 from the latched state to the unlatched state. On the other hand, in a state where the open link 32 is located at the locked position, the open link 32 does not come into contact (engage) with the release lever 31 even when moving to the operating position. Therefore, even when the user manually operates the outside door handle 5 or the inside door handle 6, the latch mechanism 20 cannot be switched to the unlatched state, and the door 1A cannot be opened.

The lock mechanism 40 can switch between a locked state (see FIGS. 4 and 5) and an unlocked state (see FIGS. 2 and 3). The locked state is a state in which the switching of the latch mechanism 20 to the unlatched state by the manual operation of the outside door handle 5 or the inside door handle 6 is prohibited. The unlocked state is a state in which the switching of the latch mechanism 20 to the unlatched state by the manual operation of the outside door handle 5 or the inside door handle 6 is allowed. The lock mechanism 40 includes a locking lever 41, a locking link 42, an active lever 43, and a locked state detection switch 44.

The locking lever 41 is supported rotatably with respect to the housing, and is selectively movable to an unlock corresponding position and a lock corresponding position by rotation. The locking lever 41 includes a gear portion 411 and a locking link engagement portion 412. The gear portion 411 is a fan-shaped gear portion that meshes with a worm 62 attached to a rotation shaft of the first motor 61. The locking link engagement portion 412 is formed at a position separated radially outward from the rotation center of the locking lever 41. One end of the locking link 42 is rotatably connected to the locking link engagement portion 412.

The locking link 42 is an elongated member. A cam pin engagement portion 421 is formed at an intermediate portion in a longitudinal direction of the locking link 42. The cam pin engagement portion 421 is formed to protrude in a direction orthogonal to the longitudinal direction of the locking link 42. The locking link engagement portion 412 of the locking lever 41 is rotatably connected to one end in the longitudinal direction of the locking link 42, and a locking link engagement portion 431 of the active lever 43 is rotatably connected to the other end in the longitudinal direction of the locking link 42. The locking link 42 moves in conjunction with the locking lever 41 to move to an unlock corresponding position when the locking lever 41 moves to the unlock corresponding position, and move to a lock corresponding position when the locking lever 41 moves to the lock corresponding position.

The active lever 43 is supported rotatably with respect to the housing so as to be coaxial with the inside lever 35 and independent of the inside lever 35. The active lever 43 is selectively movable to a lock corresponding position and an unlock corresponding position by moving in conjunction with the locking lever 41 through the locking link 42. The active lever 43 moves to the lock corresponding position when the locking lever 41 moves to the lock corresponding position, and moves to the unlock corresponding position when the locking lever 41 moves to the unlock corresponding position. The lock corresponding position is a position of one end of a movable range of the active lever 43, and the unlock corresponding position is a position of the other end of the movable range of the active lever 43. The active lever 43 is selectively biased to the lock corresponding position and the unlock corresponding position by a click spring (not illustrated). Specifically, the active lever 43 is biased to the lock corresponding position when located on the lock corresponding position side with respect to an intermediate position of the movable range, and is biased to the unlock corresponding position when located on the unlock corresponding position side with respect to the intermediate position of the movable range.

The active lever 43 includes the locking link engagement portion 431 and a spring attachment portion 432. The locking link engagement portion 431 is a portion to which the locking link 42 is rotatably connected. The spring attachment portion 432 is a portion to which the open link biasing spring 33 is attached. The open link biasing spring 33 holds the open link 32 at the locked position when the active lever 43 is located at the lock corresponding position, and holds the open link 32 at the unlocked position when the active lever 43 is located at the unlock corresponding position. However, even when the active lever 43 is located at the unlock corresponding position, the open link biasing spring 33 allows the open link 32 to be located at the locked position by elastic deformation. For example, the open link biasing spring 33 is a torsion coil spring having two parallel arms as illustrated in FIGS. 3 and 5, and is elastically deformable so as to open the two arms. The spring engagement portion 322 of the open link 32 is located between the two arms of the open link biasing spring 33 and protrudes in the direction parallel to the axial direction of the rotation axis of the open link 32.

The locked state detection switch 44 detects the state (locked state, unlocked state) of the lock mechanism 40. The locked state detection switch 44 is installed so as to be pressed by the locking lever 41 (see FIGS. 2 and 3) when the locking lever 41 is located at the unlock corresponding position (in the unlocked state), and such that the locking lever 41 is separated therefrom (see FIGS. 4 and 5) when the locking lever 41 is located at the lock corresponding position (in the locked state).

The first motor 61 is a drive source that drives the lock mechanism 40. The worm 62 is attached to the rotation shaft of the first motor 61. The gear portion 411 of the locking lever 41 meshes with the worm 62. In the lock mechanism 40, when the locking lever 41 moves to the lock corresponding position by a driving force of the first motor 61, the active lever 43 moving in conjunction with the locking lever 41 through the locking link 42 moves to the lock corresponding position to move the open link 32 to the locked position. In the lock mechanism 40, when the locking lever 41 moves to the unlock corresponding position by the driving force of the first motor 61, the active lever 43 moving in conjunction with the locking lever 41 through the locking link 42 moves to the unlock corresponding position to move the open link 32 to the unlocked position. As a result, the door lock device 11A can be switched between the locked state and the unlocked state by the driving force of the first motor 61. In the door lock device 11A, by the manual operation of the outside door handle 5 or the inside door handle 6 when the lock mechanism 40 is in the unlocked state, the latch mechanism 20 is switched from the latched state to the unlatched state to allow the opening of the door 1A.

The double lock mechanism 50 is switchable between a double lock set state (see FIGS. 6 and 7) and a double lock unset state (see FIGS. 4 and 5) when the lock mechanism 40 is in the locked state. The double lock set state is a state in which the switching of the lock mechanism 40 to the unlocked state is prohibited. The double lock unset state is a state in which the switching of the lock mechanism 40 to the unlocked state is allowed. The double lock mechanism 50 includes a push-type cam mechanism that alternately switches between the double lock set state and the double lock unset state by a pushing operation in the same direction.

The double lock mechanism 50 (push-type cam mechanism) includes a pin 51, an outer cylinder 52, an inner cylinder 53, and a pin biasing spring (not illustrated). The pin 51 is an elongated rod-shaped member. A pin cam portion (not illustrated) is formed on an outer peripheral surface of the pin 51. The pin cam portion is a ridge extending in an axial direction. The pin 51 is inserted into the outer cylinder 52 and the inner cylinder 53 such that its intermediate portion is covered and its front end portion and rear end portion are exposed, and the pin 51 is rotatable with respect to the outer cylinder 52 and the inner cylinder 53 and movable in the axial direction. The pin 51 is selectively movable to a protruding position and a retracted position by moving in the axial direction. The protruding position is a position where the pin 51 moves forward (in a direction from the rear end toward the front end). The retracted position is a position where the pin 51 moves rearward (in a direction from the front end to the rear end). Furthermore, the pin 51 is biased forward in the axial direction with respect to the outer cylinder 52 by the pin biasing spring. An outer cylinder cam portion (not illustrated) is formed on an inner peripheral surface of the outer cylinder 52. The outer cylinder cam portion has a plurality of cam teeth and cam grooves alternately formed in a circumferential direction. The pin 51 is held at the protruding position by the pin cam portion engaging with the cam groove of the outer cylinder cam portion, and is held at the retracted position by the pin cam portion engaging with the cam tooth of the outer cylinder cam portion. The inner cylinder 53 is a push member inserted into the outer cylinder 52, and is movable in the axial direction with respect to the outer cylinder 52. The inner cylinder 53 is movable to a non-switch position and a switch position by moving in the axial direction. An inner cylinder cam portion (not illustrated) is formed on an end surface of the inner cylinder 53 facing the pin cam portion. The inner cylinder cam portion is a cam surface having a plurality of crest portions and trough portions alternately formed in the circumferential direction. When the inner cylinder 53 moves from the non-switch position to the switch position, the inner cylinder cam portion presses the pin cam portion of the pin 51 with the cam surface against a biasing force of the pin biasing spring, and rotates the pin 51 while pressing the pin 51 rearward. A cam arm 531 is formed on an outer peripheral surface of the inner cylinder 53. The cam arm 531 is a tongue-shaped portion protruding in a direction orthogonal to the axial direction of the inner cylinder 53.

As illustrated in FIG. 11, in the double lock mechanism 50, the cam arm 531 is pressed so as to move the inner cylinder 53 from the non-switch position to the switch position by rotating the rotating member 73 clockwise in the drawing, whereby the cam surface of the inner cylinder cam portion engages with the pin cam portion to rotate the pin 51 while pressing the pin 51 rearward. The pressing of the cam arm 531 is released to return the inner cylinder 53 from the switch position to the non-switch position, and the pin 51 moves forward by the biasing force of the pin biasing spring, whereby the pin cam portion engages with the cam tooth or the cam groove of the outer cylinder cam portion of the outer cylinder 52. As a result, every time the cam arm 531 is operated and released, the pin cam portion alternately engages with the cam tooth and the cam groove, and the pin 51 can be alternately switched between the protruding position and the retracted position.

In the double lock mechanism 50, when the pin 51 moves to the protruding position in a state where the locking link 42 of the lock mechanism 40 is located at the lock corresponding position, the pin 51 engages with the cam pin engagement portion 421 of the locking link 42, to restrict the movement of the locking link 42 from the lock corresponding position to the unlock corresponding position (see FIGS. 6 and 7). As a result, the switching of the lock mechanism 40 to the unlocked state is prohibited (double lock set state). On the other hand, when the pin 51 moves to the retracted position, the double lock mechanism 50 releases the engagement of the pin 51 with the cam pin engagement portion 421, to allow the movement of the locking link 42 from the lock corresponding position to the unlock corresponding position (see FIGS. 4 and 5). As a result, the switching of the lock mechanism 40 to the unlocked state is allowed (double lock unset state).

A double-locked state detection switch 54 detects the state (double lock set state, double lock unset state) of the double lock mechanism 50. The double-locked state detection switch 54 is installed so as to be pressed by the pin 51 (see FIGS. 4 and 5) when the pin 51 is located at the retracted position (in the double lock unset state), and such that the pin 51 is separated therefrom (see FIGS. 6 and 7) when the pin 51 is located at the protruding position (in the double lock set state).

The second motor 71 is a drive source of the rotating member 73. A worm 72 is attached to a rotation shaft of the second motor 71. The rotating member 73 configured as a worm wheel meshes with the worm 72. The second motor 71 can drive the rotating member 73 in both forward and reverse rotation directions.

The rotating member 73 is rotationally driven by the second motor 71 to be movable to a neutral position, an unlatch corresponding position, and a cam motion position. The neutral position is an intermediate position of a movable range of the rotating member 73. The unlatch corresponding position is a position of one end of the movable range of the rotating member 73. The cam motion position is a position of the other end of the movable range of the rotating member 73. The rotating member 73 includes a release lever engagement portion 731 and a cam engagement portion 732. The release lever engagement portion 731 is configured to be engageable with and disengageable from the rotating member engagement portion 311 of the release lever 31. The rotating member engagement portion 311 of the release lever 31 is in contact with the release lever engagement portion 731 of the rotating member 73 when the rotating member 73 is at a rotational position between the neutral position and the unlatch corresponding position, and is not in contact with the release lever engagement portion 731 when the rotating member 73 is at a rotational position between the neutral position and the cam motion position. The cam engagement portion 732 is configured to be engageable with and disengageable from the cam arm 531 of the double lock mechanism 50. The cam arm 531 is in contact with the cam engagement portion 732 of the rotating member 73 when the rotating member 73 is at the rotational position between the neutral position and the cam motion position, and is not in contact with the cam engagement portion 732 when the rotating member 73 is at the rotational position between the neutral position and the unlatch corresponding position.

Therefore, as illustrated in FIGS. 12 and 13, by rotationally driving the rotating member 73 in one direction (clockwise in FIG. 12) by the second motor 71 to move the rotating member 73 from the neutral position to the unlatch corresponding position, the release lever engagement portion 731 of the rotating member 73 engages with the rotating member engagement portion 311 of the release lever 31 to press the release lever 31 and move the release lever 31 to the operating position. When the release lever 31 is moved to the operating position, the lift lever engagement portion 312 of the release lever 31 engages with the lift lever 23 to press the lift lever 23 and move the lift lever 23 to the operating position, whereby the latch mechanism 20 is switched to the unlatched state. Since the rotating member 73 directly presses the release lever 31 without the open link 32 interposed therebetween, the latch mechanism 20 can be switched to the unlatched state by the second motor 71 regardless of the state of the lock mechanism 40 and the state of the double lock mechanism 50.

As illustrated in FIGS. 10 and 11, by rotationally driving the rotating member 73 in a direction (clockwise in FIG. 11) opposite to the one direction by the second motor 71 to move the rotating member 73 from the neutral position to the cam motion position, the cam engagement portion 732 of the rotating member 73 engages with the cam arm 531 of the double lock mechanism 50 to press the cam arm 531 and move the inner cylinder 53 (push member) from the non-switch position to the switch position. The double lock mechanism 50 can be alternately switched between the double lock set state and the double lock unset state every time the operation of moving the rotating member 73 from the neutral position to the cam motion position by a driving force in the opposite direction of the second motor 71 and returning the rotating member 73 to the neutral position by a biasing force of a rotating member biasing spring is executed.

The door lock device 11A includes a key lever 45, a key switch lever 46, and a key crank 47. The key lever 45 is rotatable integrally with an inner cylinder (plug) of the key cylinder 9 by operating the key cylinder 9. The key switch lever 46 is rotatable with respect to the housing, and is movable to a neutral position, an unlock operation position, and a lock operation position in conjunction with the key lever 45. As a result, the key switch lever 46 moves from the neutral position to the unlock operation position or the lock operation position in conjunction with the operation of the key cylinder 9. The neutral position is an intermediate position of a movable range of the key switch lever 46. The unlock operation position is a position rotated in one direction from the neutral position. The lock operation position is a position rotated in a direction opposite to the one direction from the neutral position.

The key crank 47 is supported rotatably with respect to the housing, and is selectively movable between an initial position and an operating position by rotation. When the key switch lever 46 moves from the neutral position to the unlock operation position, the key crank 47 is pressed by the key switch lever 46 to be moved from the initial position to the operating position. When the key crank 47 is moved to the operating position, the key crank 47 presses the cam arm 531 to move the inner cylinder 53 from the non-switch position to the switch position. Therefore, in a case where the double lock mechanism 50 is in the double lock set state, the double lock mechanism 50 can be switched to the double lock unset state by operating the key cylinder 9. As a result, for example, even if the double lock cannot be released by the second motor 71 due to, for example, a battery of the vehicle going flat, the double lock can be urgently released manually. However, the key cylinder 9 is disposed only on the door 1A of the driver's seat, and the double lock can be urgently released only for the door 1A of the driver's seat. For this reason, the double lock-set and -released states may not match between the door 1A of the driver's seat and the other doors 1B, 1C, and 1D.

As illustrated in FIG. 14, the control device 80 is configured as a microprocessor centered on a CPU 81, and includes a ROM 82 that stores a processing program, a RAM 83 that temporarily stores data, an input/output port, a communication port, and the like in addition to the CPU 81. The control device 80 receives signals from various switches such as the locked state detection switch 44 and the double-locked state detection switch 54 for each of the door lock devices 11A, 11B, 11C, and 11D. The control device 80 also receives a signal from a door opening/closing switch 91 and a signal from a wireless remote control key 92 configured as a so-called smart key. The door opening/closing switch 91 is a switch for ordering opening/closing of the door by a user's operation, and is installed at the outside door handle 5 or on the outer panel 4 near the outside door handle 5 in each of the door 1A of the driver’s seat and the door 1B of the passenger seat. The door opening/closing switch 91 may be a push-button switch or a touch switch. The door opening/closing switch 91 may be a sensor that detects a handle operation of the outside door handle 5. The remote control key 92 can lock and unlock the doors 1A, 1B, 1C, and 1D and set and release the double lock thereof by remote operation. The control device 80 outputs a drive signal to the first motor 61 and the second motor 71 for each of the door lock devices 11A, 11B, 11C, and 11D.

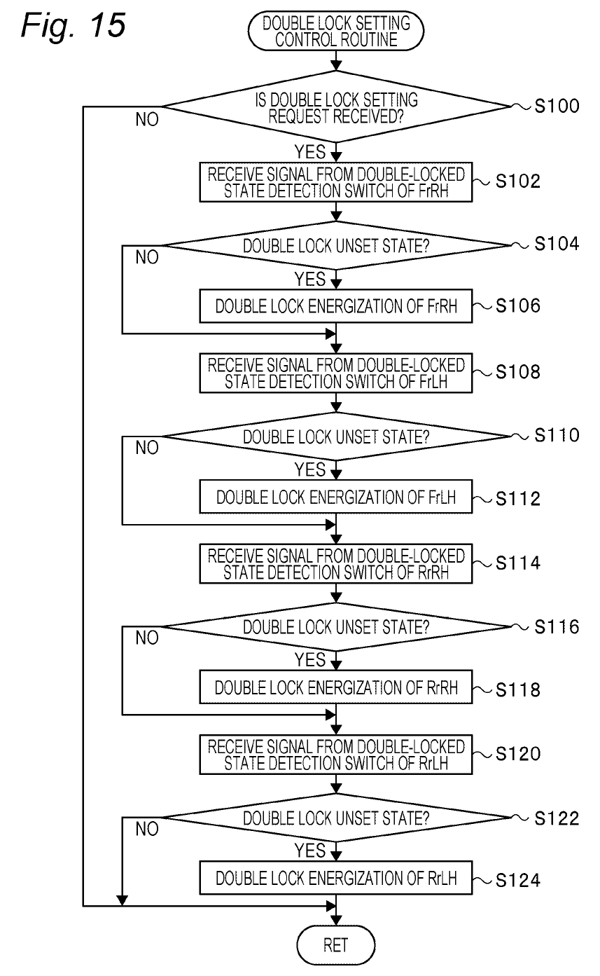

Next, an operation of the door lock system 10 configured as described above according to the present embodiment will be described. In particular, an operation when a double lock setting request is made and an operation when a double lock unsetting request is made will be described. First, the operation when the double lock setting request is made will be described, and then the operation when the double lock unsetting request is made will be described. FIG. 15 is a flowchart illustrating an example of a double lock setting control routine executed by the CPU 81 of the control device 80.

When the double lock setting control routine is executed, the CPU 81 of the control device 80 first determines whether the double lock setting request has been received from a host system (step S100). The double lock setting request is made, for example, after elapse of a predetermined time from when there is no response from the remote control key 92 carried by the user, or after the door lock is requested by operating the remote control key 92 or the door opening/closing switch 91 and the lock mechanisms 40 of the door lock devices 11A, 11B, 11C, and 11D are switched to the locked state. If determining that the double lock setting request has not been received, the CPU 81 ends this routine.

On the other hand, if determining that the double lock setting request has been received, the CPU 81 receives a signal from the double-locked state detection switch 54 of the door lock device 11A disposed in the door 1A of the driver's seat (FrRH) (step S102). Subsequently, the CPU 81 determines whether the double lock mechanism 50 of the FrRH is in the double lock unset state on the basis of the received signal (step S104). If determining that the double lock mechanism 50 of the FrRH is in the double lock unset state, the CPU 81 performs drive control of the corresponding second motor 71 so as to switch the state of the double lock mechanism 50 (step S106), and proceeds to step S108. On the other hand, if determining that the double lock mechanism 50 of the FrRH is not in the double lock unset state but in the double lock set state, the CPU 81 skips step S106 and proceeds to step S108.

Next, the CPU 81 receives a signal from the double-locked state detection switch 54 of the door lock device 11B of the passenger seat (FrLH) (step S108). Subsequently, the CPU 81 determines whether the double lock mechanism 50 of the FrLH is in the double lock unset state on the basis of the received signal (step S110). If determining that the double lock mechanism 50 of the FrLH is in the double lock unset state, the CPU 81 performs drive control of the corresponding second motor 71 so as to switch the state of the double lock mechanism 50 (step S112), and proceeds to step S114. On the other hand, if determining that the double lock mechanism 50 of the FrLH is not in the double lock unset state but in the double lock set state, the CPU 81 skips step S112 and proceeds to step S114.

Next, the CPU 81 receives a signal from the double-locked state detection switch 54 of the door lock device 11C on the right side of the rear seat (RrRH) (step S114). Subsequently, the CPU 81 determines whether the double lock mechanism 50 of the RrRH is in the double lock unset state on the basis of the received signal (step S116). If determining that the double lock mechanism 50 of the RrRH is in the double lock unset state, the CPU 81 performs drive control of the corresponding second motor 71 so as to switch the state of the double lock mechanism 50 (step S118), and proceeds to step S120. On the other hand, if determining that the double lock mechanism 50 of the RrRH is not in the double lock unset state but in the double lock set state, the CPU 81 skips step S118 and proceeds to step S120.

Next, the CPU 81 receives a signal from the double-locked state detection switch 54 of the door lock device 11D on the left side of the rear seat (RrLH) (step S120). Subsequently, the CPU 81 determines whether the double lock mechanism 50 of the RrLH is in the double lock unset state on the basis of the received signal (step S122). If determining that the double lock mechanism 50 of the RrLH is in the double lock unset state, the CPU 81 performs drive control of the corresponding second motor 71 so as to switch the state of the double lock mechanism 50 (step S124), and ends this routine. On the other hand, if determining that the double lock mechanism 50 of the RrLH is not in the double lock unset state but in the double lock set state, the CPU 81 skips step S124 and ends this routine.

The second motor 71 is used for switching the state of the latch mechanism 20 and switching the state of the double lock mechanism 50. The double lock mechanism 50 is configured to alternately switch between the double lock set state and the double lock unset state by driving the second motor 71 in the direction opposite to that in a case where the second motor 71 switches the state of the latch mechanism 20. For this reason, for example, if the double lock of the door 1A of the driver's seat is urgently released manually, the double lock-set and -released states may not match between the door 1A of the driver's seat and the other doors 1B, 1C, and 1D. In the present embodiment, when receiving the double lock setting request, the CPU 81 checks whether the double lock mechanism 50 is in the double lock unset state using the double-locked state detection switch 54 for each of the door lock devices 11A, 11B, 11C, and 11D of the doors 1A, 1B, 1C, and 1D of the vehicle. For the door lock device in the double lock unset state, the CPU 81 performs the drive control of the corresponding second motor 71 so as to switch the state of the double lock mechanism 50, and for the door lock device in the double lock set state, does not perform the drive control of the corresponding second motor 71. As a result, the states of the double lock mechanisms 50 of all the doors 1A, 1B, 1C, and 1D can be matched to the double lock set state in response to the double lock setting request.

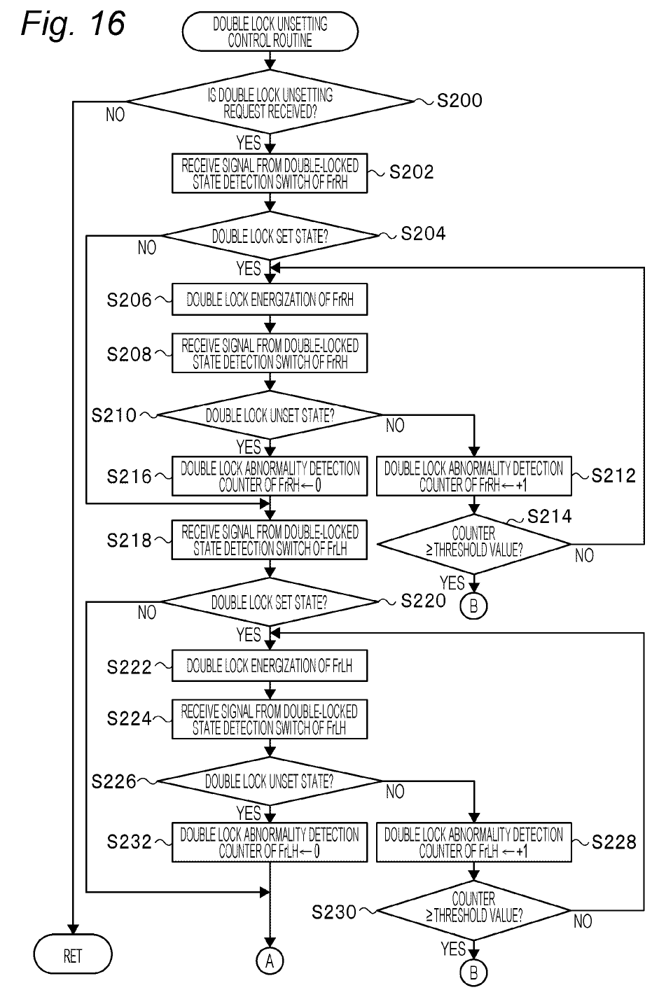

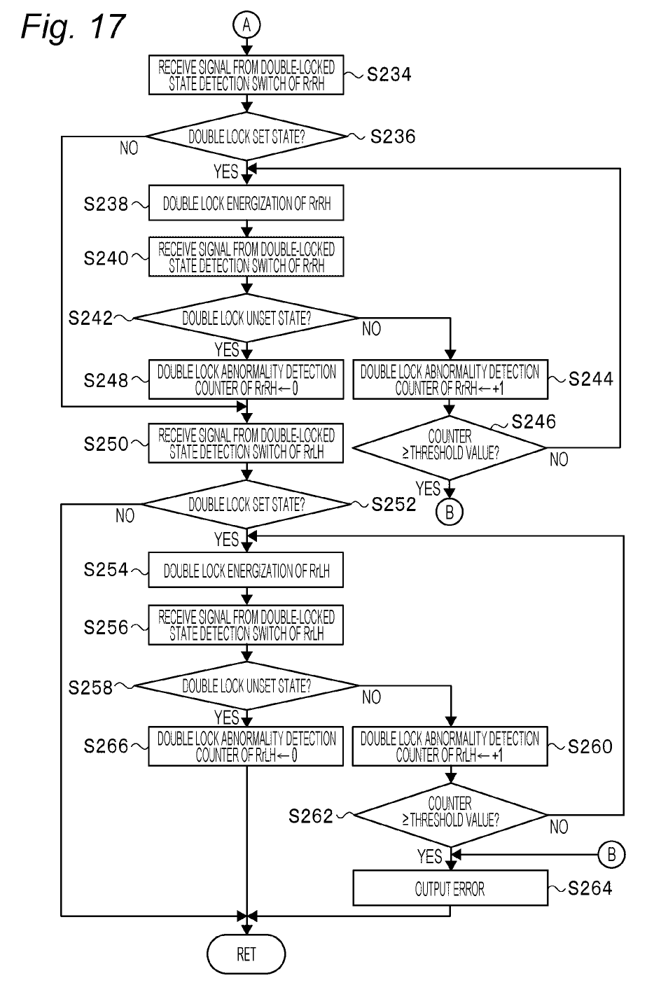

Next, the operation when the double lock unsetting request is made will be described. FIGS. 16 and 17 are flowcharts illustrating an example of a double lock unsetting control routine executed by the CPU 81.

When the double lock unsetting control routine is executed, the CPU 81 first determines whether the double lock unsetting request has been received from a host system (step S200). The double lock unsetting request is made, for example, when releasing of the door lock is requested by operating the remote control key 92 or the door opening/closing switch 91. After the double lock is released, the door lock is also released. If determining that the double lock unsetting request has not been received, the CPU 81 ends this routine.

On the other hand, if determining that the double lock unsetting request has been received, the CPU 81 receives a signal from the double-locked state detection switch 54 of the door lock device 11A disposed in the door 1A of the driver's seat (FrRH) (step S202). Subsequently, the CPU 81 determines whether the double lock mechanism 50 of the FrRH is in the double lock set state on the basis of the received signal (step S204). If determining that the double lock mechanism 50 of the FrRH is in the double lock set state, the CPU 81 performs drive control of the corresponding second motor 71 so as to switch the state of the double lock mechanism 50 (step S206). Next, the CPU 81 receives a signal from the double-locked state detection switch 54 of the FrRH (step S208). Subsequently, the CPU 81 determines whether the double lock mechanism 50 of the FrRH has been switched to the double lock unset state on the basis of the received signal (step S210). If determining that the double lock mechanism 50 of the FrRH has not been switched to the double lock unset state, the CPU 81 increments a double lock abnormality detection counter for the FrRH by a value of 1 (step S212), and determines whether the double lock abnormality detection counter for the FrRH is equal to or more than a threshold value (for example, a value of 2 or a value of 3) (step S214). If determining that the double lock abnormality detection counter for the FrRH is less than the threshold value, the CPU 81 returns to step S206 and repeats the processing.

In a case where the double lock mechanism 50 of the FrRH is not switched to the double lock unset state in the process of repeating the processing of steps S206 to S214 and the CPU 81 determines at step S214 that the double lock abnormality detection counter for the FrRH becomes equal to or more than the threshold value, the CPU 81 outputs an error (step S264) and ends this routine. On the other hand, if determining at step S210 that the double lock mechanism 50 of the FrRH has been switched to the double lock unset state, the CPU 81 resets the double lock abnormality detection counter for the FrRH to a value of 0 (step S216), and proceeds to step S218.

Next, the CPU 81 receives a signal from the double-locked state detection switch 54 of the door lock device 11B of the passenger seat (FrLH) (step S218). Subsequently, the CPU 81 determines whether the double lock mechanism 50 of the FrLH is in the double lock set state on the basis of the received signal (step S220). If determining that the double lock mechanism 50 of the FrLH is in the double lock set state, the CPU 81 performs drive control of the corresponding second motor 71 so as to switch the state of the double lock mechanism 50 (step S222). Next, the CPU 81 receives a signal from the double-locked state detection switch 54 of the FrLH (step S224). Subsequently, the CPU 81 determines whether the double lock mechanism 50 of the FrLH has been switched to the double lock unset state on the basis of the received signal (step S226). If determining that the double lock mechanism 50 of the FrLH has not been switched to the double lock unset state, the CPU 81 increments a double lock abnormality detection counter for the FrLH by a value of 1 (step S228), and determines whether the double lock abnormality detection counter for the FrLH is equal to or more than a threshold value (for example, a value of 2 or a value of 3) (step S230). If determining that the double lock abnormality detection counter for the FrLH is less than the threshold value, the CPU 81 returns to step S222 and repeats the processing.

In a case where the double lock mechanism 50 of the FrLH is not switched to the double lock unset state in the process of repeating the processing of steps S222 to S230 and the CPU 81 determines at step S230 that the double lock abnormality detection counter for the FrLH becomes equal to or more than the threshold value, the CPU 81 outputs an error (step S264) and ends this routine. On the other hand, if determining at step S226 that the double lock mechanism 50 of the FrLH has been switched to the double lock unset state, the CPU 81 resets the double lock abnormality detection counter for the FrLH to a value of 0 (step S232), and proceeds to step S234.

Next, the CPU 81 receives a signal from the double-locked state detection switch 54 of the door lock device 11C on the right side of the rear seat (RrRH) (step S234). Subsequently, the CPU 81 determines whether the double lock mechanism 50 of the RrRH is in the double lock set state on the basis of the received signal (step S236). If determining that the double lock mechanism 50 of the RrRH is in the double lock set state, the CPU 81 performs drive control of the corresponding second motor 71 so as to switch the state of the double lock mechanism 50 (step S238). Next, the CPU 81 receives a signal from the double-locked state detection switch 54 of the RrRH (step S240). Subsequently, the CPU 81 determines whether the double lock mechanism 50 of the RrRH has been switched to the double lock unset state on the basis of the received signal (step S242). If determining that the double lock mechanism 50 of the RrRH has not been switched to the double lock unset state, the CPU 81 increments a double lock abnormality detection counter for the RrRH by a value of 1 (step S244), and determines whether the double lock abnormality detection counter for the RrRH is equal to or more than a threshold value (for example, a value of 2 or a value of 3) (step S246). If determining that the double lock abnormality detection counter for the RrRH is less than the threshold value, the CPU 81 returns to step S238 and repeats the processing.

In a case where the double lock mechanism 50 of the RrRH is not switched to the double lock unset state in the process of repeating the processing of steps S238 to S246 and the CPU 81 determines at step S246 that the double lock abnormality detection counter for the RrRH becomes equal to or more than the threshold value, the CPU 81 outputs an error (step S264) and ends this routine. On the other hand, if determining at step S242 that the double lock mechanism 50 of the RrRH has been switched to the double lock unset state, the CPU 81 resets the double lock abnormality detection counter for the RrRH to a value of 0 (step S248), and proceeds to step S250.

Next, the CPU 81 receives a signal from the double-locked state detection switch 54 of the door lock device 11D on the left side of the rear seat (RrLH) (step S250). Subsequently, the CPU 81 determines whether the double lock mechanism 50 of the RrLH is in the double lock set state on the basis of the received signal (step S252). If determining that the double lock mechanism 50 of the RrLH is in the double lock set state, the CPU 81 performs drive control of the corresponding second motor 71 so as to switch the state of the double lock mechanism 50 (step S254). Next, the CPU 81 receives a signal from the double-locked state detection switch 54 of the RrLH (step S256). Subsequently, the CPU 81 determines whether the double lock mechanism 50 of the RrLH has been switched to the double lock unset state on the basis of the received signal (step S258). If determining that the double lock mechanism 50 of the RrLH has not been switched to the double lock unset state, the CPU 81 increments a double lock abnormality detection counter for the RrLH by a value of 1 (step S260), and determines whether the double lock abnormality detection counter for the RrLH is equal to or more than a threshold value (for example, a value of 2 or a value of 3) (step S262). If determining that the double lock abnormality detection counter for the RrLH is less than the threshold value, the CPU 81 returns to step S254 and repeats the processing.

In a case where the double lock mechanism 50 of the RrLH is not switched to the double lock unset state in the process of repeating the processing of steps S254 to S262 and the CPU 81 determines at step S262 that the double lock abnormality detection counter for the RrLH becomes equal to or more than the threshold value, the CPU 81 outputs an error (step S264) and ends this routine. On the other hand, if determining at step S258 that the double lock mechanism 50 of the RrLH has been switched to the double lock unset state, the CPU 81 resets the double lock abnormality detection counter for the RrLH to a value of 0 (step S266), and ends this routine.

As described above, when receiving the double lock unsetting request, the CPU 81 checks whether the double lock mechanism 50 is in the double lock set state using the double-locked state detection switch 54 for each of the door lock devices 11A, 11B, 11C, and 11D of the doors 1A, 1B, 1C, and 1D of the vehicle. For the door lock device in the double lock set state, the CPU 81 performs the drive control of the corresponding second motor 71 so as to switch the state of the double lock mechanism 50, and for the door lock device in the double lock unset state, does not perform the drive control of the corresponding second motor 71. As a result, the states of the double lock mechanisms 50 of all the doors 1A, 1B, 1C, and 1D can be matched to the double lock unset state in response to the double lock unsetting request. In a case where the double lock mechanism 50 is not switched to the double lock unset state even when the drive control of the corresponding second motor 71 of the door lock device in the double lock set state is performed, the CPU 81 repeats the drive control of the second motor 71 until the number of repetitions reaches a predetermined number of times (until the double lock abnormality detection counter becomes equal to or more than the threshold value), so that the double lock can be released more reliably.

Furthermore, the double lock mechanism 50 is configured to alternately switch between the double lock set state and the double lock unset state by the pushing operation, and the switching to the double lock unset state and the switching to the unlatched state are performed by the single motor (the second motor 71), so that the manufacturing cost can be further reduced by reducing the number of components.

It should be noted that the present disclosure is not limited to the above-described embodiment at all, and it goes without saying that the present disclosure can be implemented in various modes as long as it falls within the technical scope of the present disclosure.

For example, in the above-described embodiment, the first motor 61 is used to drive the lock mechanism 40, and the second motor 71 is used to drive both the latch mechanism 20 and the double lock mechanism 50. However, the first motor 61 may be used to drive both the lock mechanism 40 and the double lock mechanism 50, and the second motor 71 may be used to drive the latch mechanism 20. Alternatively, different motors may be used for driving the latch mechanism 20, driving the lock mechanism 40, and driving the double lock mechanism 50.

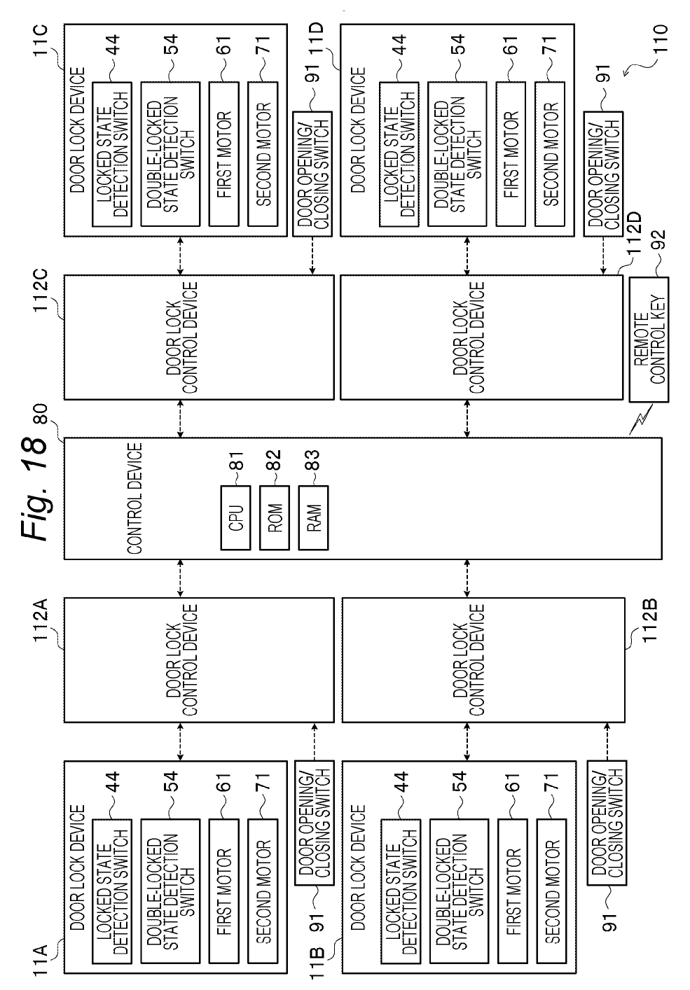

In the embodiment described above, the door lock system 10 includes the single control device 80 that controls the plurality of door lock devices 11A, 11B, 11C, and 11D. However, as in a door lock system 110 illustrated in FIG. 18, the same number of door lock control devices 112A, 112B, 112C, and 112D that respectively control the plurality of door lock devices 11A, 11B, 11C, and 11D may be provided separately from the control device 80. The control device 80 is configured to be able to communicate with the door lock control devices 112A, 112B, 112C, and 112D and receive a signal from the remote control key 92. In this case, in the double lock setting control routine, for example, if receiving the double lock setting request at step S100, the control device 80 may instruct the door lock control device 112A to execute the processing of steps S102 to S106, instruct the door lock control device 112B to execute the processing of steps S108 to S112, instruct the door lock control device 112C to execute the processing of steps S114 to S118, and instruct the door lock control device 112D to execute the processing of steps S120 to S124. In the double lock unsetting control routine, for example, if receiving the double lock unsetting request at step S200, the control device 80 may instruct the door lock control device 112A to execute the processing of steps S202 to S216 and S264, instruct the door lock control device 112B to execute the processing of steps S218 to S232 and S264, instruct the door lock control device 112C to execute the processing of steps S234 to S248 and S264, and instruct the door lock control device 112D to execute the processing of steps S250 to S266. The door lock control devices 112A, 112B, 112C, and 112D control the corresponding door lock devices 11A, 11B, 11C, and 11D, respectively, by parallel processing.

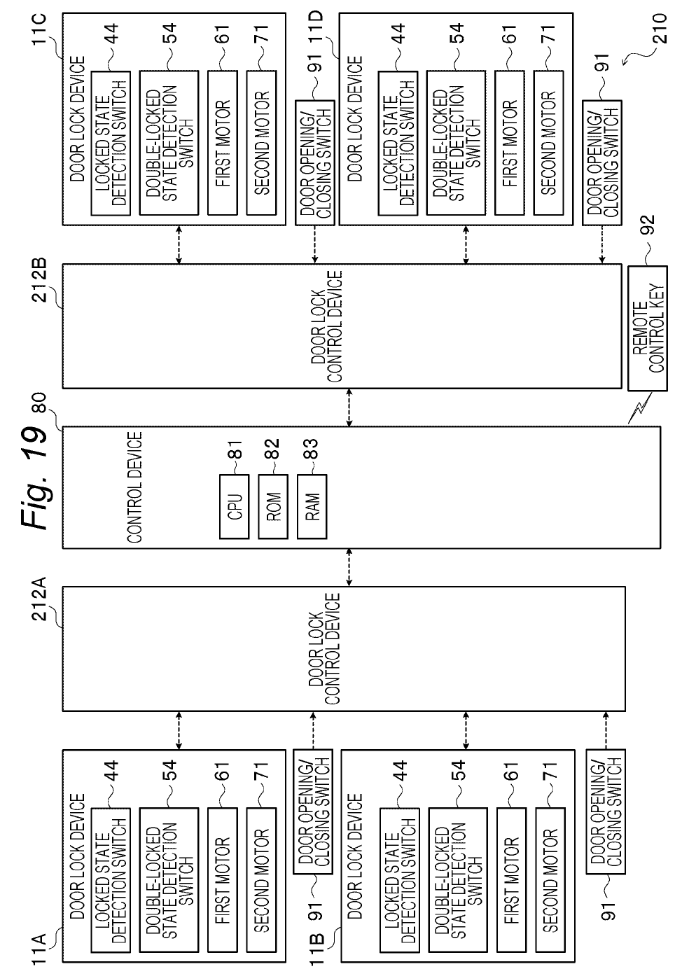

In addition, as in a door lock system 210 illustrated in FIG. 19, a door lock control device 212A that controls some (for example, the door lock devices 11A and 11B) of the plurality of door lock devices 11A, 11B, 11C, and 11D and a door lock control device 212B that controls the others (for example, the door lock devices 11C and 11D) may be provided separately from the control device 80. The control device 80 is configured to be able to communicate with the door lock control devices 212A and 212B and receive a signal from the remote control key 92. In this case, in the double lock setting control routine, for example, if receiving the double lock setting request at step S100, the control device 80 may instruct the door lock control device 212A to execute the processing of steps S102 to S112, and instruct the door lock control device 212B to execute the processing of steps S114 to S124. In the double lock unsetting control routine, for example, if receiving the double lock unsetting request at step S200, the control device 80 may instruct the door lock control device 212A to execute the processing of steps S202 to S232 and S264, and instruct the door lock control device 212B to execute the processing of steps S234 to S266. The door lock control devices 212A and 212B control the corresponding door lock devices 11A, 11B, 11C, and 11D by parallel processing.

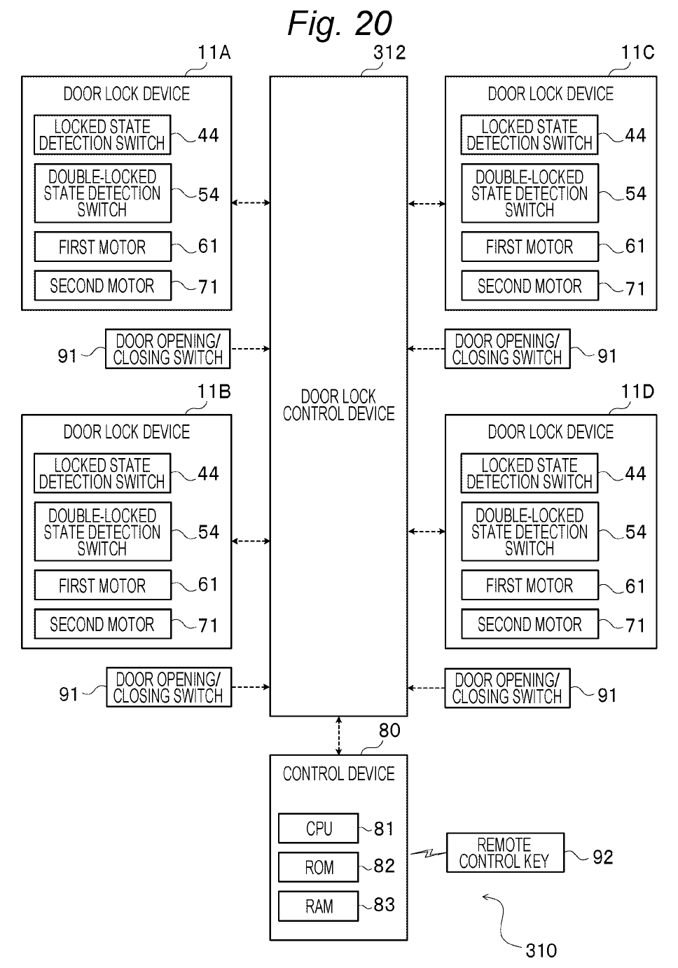

Furthermore, as in a door lock system 310 illustrated in FIG. 20, a single door lock control device 312 that controls the plurality of door lock devices 11A, 11B, 11C, and 11D may be provided separately from the control device 80 that receives a signal from the remote control key 92.

The present disclosure is applicable to, for example, the manufacturing industry of the door lock system.

<1> A door lock system includes: a plurality of door lock devices respectively provided in a plurality of doors of a vehicle; and a control device configured to control the plurality of door lock devices, in which each of the plurality of door lock devices includes: a latch mechanism configured to selectively form a latched state in which a corresponding door is held in a closed state, and an unlatched state in which opening of the corresponding door is allowed; a lock mechanism configured to selectively form a locked state in which switching of the latch mechanism to the unlatched state is prohibited, and an unlocked state in which the switching of the latch mechanism to the unlatched state is allowed; a double lock mechanism configured to selectively form a double lock set state in which switching of the lock mechanism to the unlocked state is prohibited, and a double lock unset state in which the switching of the lock mechanism to the unlocked state is allowed; a motor configured to drive the double lock mechanism; and a detector configured to detect a state of the double lock mechanism, the double lock mechanism alternately switches between the double lock set state and the double lock unset state by driving the motor in one direction, and when switching of the state of the double lock mechanism is requested, the control device performs drive control in the one direction of the motor of, among the plurality of door lock devices, the door lock device where the state of the double lock mechanism detected by the detector does not match a state of a requested switch destination, and does not perform drive control in the one direction of the motor of the door lock device where the state of the double lock mechanism detected by the detector matches the state of the requested switch destination.

In the door lock system of the present disclosure, when switching to the double lock unset state is requested in a case where double lock states are different between one door and the other doors, the states of the double lock mechanisms can be matched to the double lock unset state in all the doors. As a result, it is possible to prevent unintentional mismatch of the states of the double lock mechanisms between the doors.

<2> In the door lock system, when switching to the double lock unset state is requested, the control device performs the drive control in the one direction of the motor of, among the plurality of door lock devices, the door lock device where the state of the double lock mechanism detected by the detector is the double lock set state, and does not perform the drive control in the one direction of the motor of the door lock device where the state of the double lock mechanism detected by the detector is the double lock unset state.

<3> In the door lock system, the control device repeats the drive control of the corresponding motor in the one direction until the state of the double lock mechanism detected by the corresponding detector is changed to the double lock unset state or a number of repetitions reaches a predetermined number of times in a case where the state of the double lock mechanism detected by the corresponding detector is not changed from the double lock set state after the drive control of the corresponding motor in the one direction.

<4> In the door lock system, when switching to the double lock set state is requested, the control device performs the drive control in the one direction of the motor of, among the plurality of door lock devices, the door lock device where the state of the double lock mechanism detected by the detector is the double lock unset state, and does not perform the drive control in the one direction of the motor of the door lock device where the state of the double lock mechanism detected by the detector is the double lock set state.

In the door lock system of the present disclosure, when switching to the double lock set state is requested in a case where double lock states are different between one door and the other doors, the states of the double lock mechanisms can be matched to the double lock set state in all the doors. As a result, it is possible to prevent unintentional mismatch of the states of the double lock mechanisms between the doors.

<5> The door lock system includes: a first motor configured to drive the lock mechanism; and a second motor configured to drive the latch mechanism, in which the double lock mechanism alternately switches between the double lock set state and the double lock unset state by driving the second motor as the motor in a direction opposite to a direction in which the second motor drives the latch mechanism.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door lock system comprising: a plurality of door lock devices respectively provided in a plurality of doors of a vehicle; and a control device configured to control the plurality of door lock devices, wherein
each of the plurality of door lock devices includes: a latch mechanism configured to selectively form a latched state in which a corresponding door is held in a closed state, and an unlatched state in which opening of the corresponding door is allowed; a lock mechanism configured to selectively form a locked state in which switching of the latch mechanism to the unlatched state is prohibited, and an unlocked state in which the switching of the latch mechanism to the unlatched state is allowed; a double lock mechanism configured to selectively form a double lock set state in which switching of the lock mechanism to the unlocked state is prohibited, and a double lock unset state in which the switching of the lock mechanism to the unlocked state is allowed; a motor configured to drive the double lock mechanism; and a detector configured to detect a state of the double lock mechanism,
the double lock mechanism alternately switches between the double lock set state and the double lock unset state by driving the motor in one direction, and
when switching of the state of the double lock mechanism is requested, the control device performs drive control in the one direction of the motor of, among the plurality of door lock devices, the door lock device where the state of the double lock mechanism detected by the detector does not match a state of a requested switch destination, and does not perform drive control in the one direction of the motor of the door lock device where the state of the double lock mechanism detected by the detector matches the state of the requested switch destination.

2. The door lock system according to claim 1, wherein
when switching to the double lock unset state is requested, the control device performs the drive control in the one direction of the motor of, among the plurality of door lock devices, the door lock device where the state of the double lock mechanism detected by the detector is the double lock set state, and does not perform the drive control in the one direction of the motor of the door lock device where the state of the double lock mechanism detected by the detector is the double lock unset state.

3. The door lock system according to claim 2, wherein
the control device repeats the drive control of the corresponding motor in the one direction until the state of the double lock mechanism detected by the corresponding detector is changed to the double lock unset state or a number of repetitions reaches a predetermined number of times in a case where the state of the double lock mechanism detected by the corresponding detector is not changed from the double lock set state after the drive control of the corresponding motor in the one direction.

4. The door lock system according to claim 1, wherein
when switching to the double lock set state is requested, the control device performs the drive control in the one direction of the motor of, among the plurality of door lock devices, the door lock device where the state of the double lock mechanism detected by the detector is the double lock unset state, and does not perform the drive control in the one direction of the motor of the door lock device where the state of the double lock mechanism detected by the detector is the double lock set state.

5. The door lock system according to claim 1, the door lock system comprising:
a first motor configured to drive the lock mechanism; and
a second motor configured to drive the latch mechanism, wherein
the double lock mechanism alternately switches between the double lock set state and the double lock unset state by driving the second motor as the motor in a direction opposite to a direction in which the second motor drives the latch mechanism.

6. The door lock system according to claim 2, the door lock system comprising:
a first motor configured to drive the lock mechanism; and
a second motor configured to drive the latch mechanism, wherein
the double lock mechanism alternately switches between the double lock set state and the double lock unset state by driving the second motor as the motor in a direction opposite to a direction in which the second motor drives the latch mechanism.

7. The door lock system according to claim 3, the door lock system comprising:
a first motor configured to drive the lock mechanism; and
a second motor configured to drive the latch mechanism, wherein
the double lock mechanism alternately switches between the double lock set state and the double lock unset state by driving the second motor as the motor in a direction opposite to a direction in which the second motor drives the latch mechanism.

8. The door lock system according to claim 4, the door lock system comprising:
a first motor configured to drive the lock mechanism; and
a second motor configured to drive the latch mechanism, wherein
the double lock mechanism alternately switches between the double lock set state and the double lock unset state by driving the second motor as the motor in a direction opposite to a direction in which the second motor drives the latch mechanism.
